(19) United States
(12) Patent Application Publication
(10) Pub. No.: US 2012/0305556 A1
(43) Pub. Date: Dec. 6, 2012

(54) Cosmetic applicator, precursor and related manufacturing method

(76) Inventors: Jun Murase, Nagoya-city (JP); Tomotaka Hara, Hadano-city (JP)

(21) Appl. No.: 13/134,145

(22) Filed: May 31, 2011

(51) Int. Cl. B65D 51/00; B05D 3/12; B32B 3/26; B28B 7/36

(52) U.S. Cl. 220/200; 425/98; 427/299; 428/304.4

(57) ABSTRACT

A cosmetic applicator, such as a gel puff, includes a body enclosing a gel. The body lacks any gate mark as the result of being manufactured by a process including providing a base layer in a mold to form a cavity, providing the gel material in the cavity, and providing a removable cover for covering an exposed surface of the gel material so as to fully enclose it and form a precursor. The precursor is then removed from the mold, the cover removed, and a surface layer is applied to the exposed surface of the gel material to complete the applicator and process.

The Patent or application file contains at least one drawing executed in color. Copies of this patent or patent application publication with color drawing(s) will be provided by the Office upon request and payment of the necessary fees.

### TECHNICAL FIELD

This disclosure relates to the art of applicators for applying a liquid to a surface and, more particularly, to an improved cosmetic applicator, precursor, and related method of manufacturing the same.

### BACKGROUND OF THE INVENTION

Efforts have been made to produce applicators in the form of so-called “gel puffs,” which are spongy objects useful for the application of a liquid foundation as a cosmetic. Such puffs have been conventionally formed by way of a molding process. As shown in FIG. 1 and with reference to Japanese Patent Application Publication 2009-201833 (the disclosure of which is incorporated herein by reference), this molding process involves the injection of a liquid gel material under pressure into an interior compartment of a covering C that ultimately forms the outermost layer of the applicator and contains the gel once cured. This injection is typically done through a channel N including a gate T formed between the upper portion U and a lower portion L of a closed mold M.

Consequently, as shown in FIG. 2, the outer surface of the resulting applicator A is subject to an imperfection 1, which may be manually plugged with material in a further processing step. This is troublesome not only from an efficiency standpoint, but also from an aesthetic standpoint (especially if the material is transparent) and a functional standpoint (since it is desirable during the application of the cosmetic using the puff for the application surface to be as smooth and perfect as possible to prevent streaking when applying the foundation). The injection of the gel material into the closed mold cavity may cause it to mix with the air and lead to the undesirable formation of bubbles, and result in unpredictable internal imperfections in the resulting gel puff that cannot be readily repaired.

Accordingly, it would be desirable to produce such a puff in an easy and efficient manner that avoids the requirement of a gate mark on the outer surface.

### SUMMARY OF THE INVENTION

One aspect of the disclosure pertains to a cosmetic applicator, which may be formed by a molding process. The applicator comprises a body including a covering fully enclosing a gel material, the covering having a molded portion. Advantageously, the covering lacks any gate mark or other imperfection resulting from the molding process.

In one embodiment, the covering includes a non-molded portion, which may comprise a spray coating. The gel material may comprise a liquid segment gel, such as polyurethane, which maintains a gelled state (soft gelled elastomer) regardless of the content of moisture at room temperature. The covering may also comprise polyurethane, so as to provide a homogeneous structure for the applicator.

Another aspect of the disclosure pertains to a precursor for forming a cosmetic applicator using a mold having first and second portions forming a closed mold cavity. The precursor comprises a base layer positioned in the cavity and a gel material at least partially covering the base layer. A cover is provided for fully enclosing the gel material.

In one embodiment, the cover comprises a sheet of material. Preferably, a surface of the sheet exposed to the gel material in the cavity includes a lubricious coating. This facilitates removal of the sheet once the molding operation is complete to form the precursor, which may then be used to form the cosmetic applicator.

A further aspect of the disclosure relates to an apparatus for forming a cosmetic applicator including a gel material. The apparatus comprises a mold portion including an open cavity. A base layer is provided for positioning in the open cavity. A dispenser is also provided for dispensing the gel material onto the base layer in the open cavity of the mold portion.

In one embodiment, the apparatus may further include a cover for covering the gel material. Preferably, the cover comprises a sheet having a lubricious coating for contacting the gel material. The mold portion may comprise a lower mold portion, and the apparatus may further include an upper mold portion for completing the cavity to enclose the cover, the gel material, and the base layer.

Still a further aspect of the invention is a method of forming a cosmetic applicator without a gate mark from a precursor having a cover over a surface of a gel material. The method comprises removing the cover from the precursor to expose the surface of the gel material. The method further comprises applying a layer to the surface.

In one embodiment, the applying step comprises applying the surface layer by spraying a material on the surface of the gel material not covered by the base layer. Prior to the removing step, the method may further include the step of providing the gel material in a recess formed by the base layer. The method may also include the step of molding the gel material in the recess with the cover to form the precursor. Still further, the method may include the step of rolling the cover onto the surface of the gel material. Preferably, the method also includes the step of removing the cover before the applying step.

Yet a further aspect of the disclosure relates to a method of forming a precursor for a cosmetic applicator. The method comprises providing a base layer having a recess including a gel material in a mold, exposing a surface of the gel material in the recess, and covering the exposed surface to fully enclose the gel material and form the precursor.

In one embodiment, the method further includes the step of molding the precursor. After molding, the method may also comprise removing the cover to expose a surface of the gel material, and applying a layer to the exposed surface of the gel material. Preferably, the applying step comprises spraying a material on the exposed surface.

### BRIEF DESCRIPTION OF THE DRAWINGS

FIG. 1 is a schematic illustration of a prior art molding process for forming a cosmetic applicator in the nature of a gel puff;

FIG. 2 is a cross-sectional depiction of the gel puff formed by the molding process of FIG. 1;

FIG. 3 is a schematic diagram of a mold for use in manufacturing a gel puff according to the disclosure;

FIG. 4 is a schematic diagram illustrating the steps of introducing a base layer and the gel material into the mold;

FIG. 5 schematically illustrates the step of covering the exposed surface of the gel material;

FIG. 6 is a cross-sectional side view of the precursor for forming the gel puff;

FIG. 7 is a cross-sectional side view of the base layer and gel material after further processing;

FIG. 8 schematically illustrates applying a coating to the exposed surface of the gel material to complete the covering;

FIG. 9 is a cross-sectional side view of the gel puff formed by the process of the preferred embodiment; and

FIGS. 10-20 show various examples of gel puffs according to the disclosure.

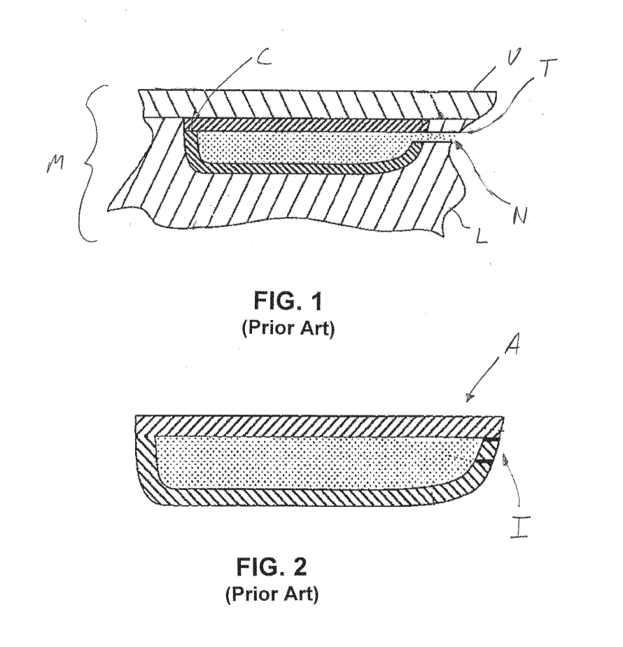

### DETAILED DESCRIPTION OF THE PREFERRED EMBODIMENTS

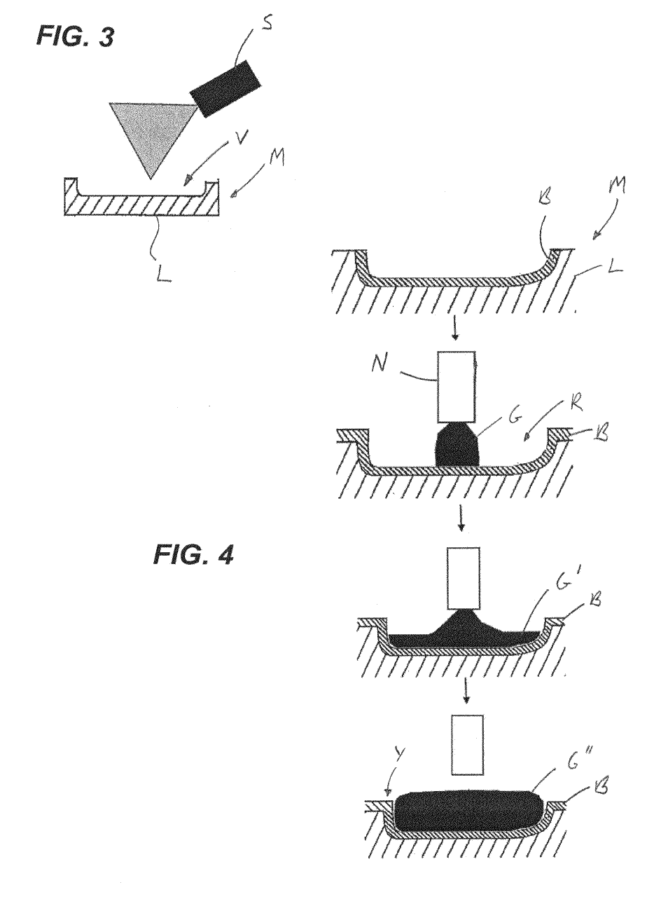

With reference now to FIGS. 3-9, a preferred embodiment of a method for manufacturing a cosmetic applicator 10 in the form of a gel puff (FIG. 9) is now described. As will be understood upon reviewing the description that follows, the applicator 10 includes a covering 12 completely enclosing a gel material G, and including a portion formed by molding. Despite using a molding process, the manufacturing is such that the covering 12, which is preferably the outermost layer, includes no gate mark. For purposes of this disclosure, the term “gate mark” refers to the vestige that normally appears on an outer surface of a completed object as the result of the creation of an opening or passage through the outer surface to inject a material into an interior compartment. The concept of the gate mark encompasses any visible plug or other processing used to close the opening in the covering once the molding process is complete.

The initial step of the present method involves providing a mold M for making the applicator. As illustrated in FIG. 3, this step may involve first providing a release agent on the surface of a cavity V of a lower mold portion L, in order to facilitate release of the molded product. This lower mold portion L is adapted to mate and register with an upper mold portion (not shown) to form a closed cavity (that is, one without any channel, gate, or other inlet). The application of the agent may be by way of an applicator for forming a thin, even layer, such as a sprayer S or other atomizer. The release agent is preferably allowed to dry before proceeding, which may involve heating to expedite the process.

Next, with reference to FIG. 4, a base layer B is provided in the cavity V of the lower mold portion L. This base layer B may comprise an elastomer, such as a polyurethane. Preferably, this layer is applied as a thin film and, most preferably, at a thickness of about 0.02 millimeters to about 0.1 millimeters. The base layer B may also be applied by spraying using a sprayer or like device (not shown), and is preferably allowed to dry before proceeding, again possibly with heating.

The next step is to apply a gel material G onto the base layer B in the mold M. The introduction of the gel material G may be by way of a nozzle N to first partially (G′) and then substantially (G″) fill the recess R formed by the combined action of the base layer B and the cavity V. Advantageously, the use of a nozzle N in the proposed manner allows for the gel material G to be introduced without forming any significant amount of air bubbles, which can lead to undesirable imperfections in the resulting applicator 10. The filling may be done such that the upper surface of the gel material G provides a meniscus projecting slightly above the corresponding periphery Y of the lower mold portion L. In any case, the total volume of the gel material G introduced should substantially correspond to the volume of the recess R (which corresponds to the remaining volume of the cavity V of the lower portion L of the mold M with the base layer B in place).

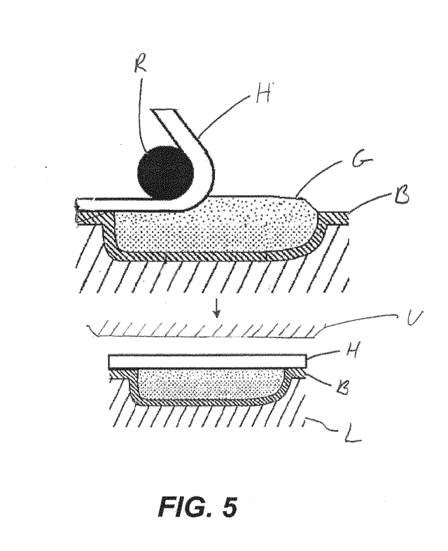

As shown in FIG. 5, the gel material G in the mold M may then be covered by a temporary cover. This cover is preferably a thin film, such as a sheet H of a polyethylene terephthalate (PET) material. Most preferably, the surface of the side of the sheet H for contacting the exposed surface of the uncured gel material G is coated with a lubricious material, such as silicon. Application of the sheet H may be by way of a roll bar R, which may help to smooth out the gel material G and ensure it occupies the entirety of the recess R.

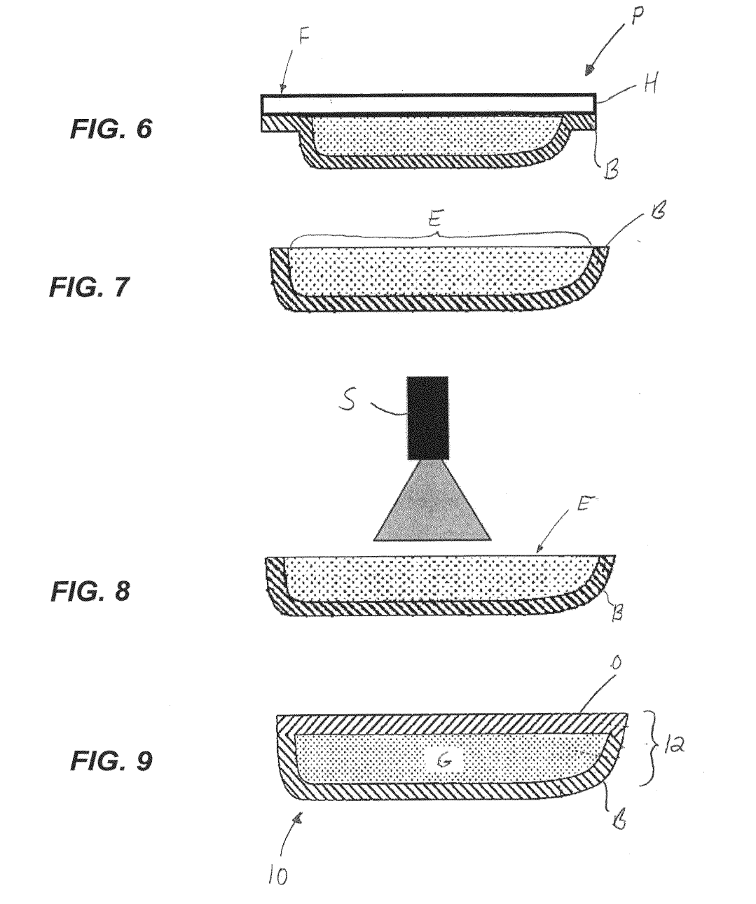

The upper portion U of the mold M may then be applied to close the cavity V, and the contents heated. The heating may be at a temperature of between about 40 to about 140° C., preferably about 60 to about 100° C. and for a time of approximately 5 minutes to approximately 4 hours. The resulting precursor P may then be removed from the mold (FIG. 6), which is facilitated by the presence of the sheet H (which is stiffer than the usual elastomer forming the exposed portion of the article when the upper mold portion is removed). The precursor P and then allowed to cool and cure for a suitable time, which may depend on a variety of factors (including material, thickness, etc.).

Once the precursor P is formed, any flashing F created during the molding may be removed, such as by cutting. The presence of the sheet H also advantageously lends rigidity to the underlying portion of the base layer B along the flashing F, making it easier to remove. The sheet H may also be removed to expose a portion E of the now-cured gel material G, such as the upper surface, as shown in FIG. 7. As should be appreciated, this exposed portion E of the gel material G is tacky or sticky.

To complete the applicator 10, the exposed surface of the gel material G is covered. This may be done by providing a coating, such as polyurethane, to create an over layer O that covers the exposed portion E of the gel material G. The application may involve using a sprayer S, as shown in FIG. 8.

The resulting structure may then be heated to cure the spray coating forming the over layer O of the covering 12 and form the completed applicator 10. The portion of the over layer O formed by the spray coating may comprise a minority of the covering 12 of the applicator 10, which in completed form is shown in the cross-sectional side view of FIG. 9.

In terms of composition, the gel material G may be an elastomer including but not limited to polyurethane. Preferably, the polyurethane gel is a 2-component liquid polyurethane elastomer which made by mixing and heat curing with polyol and isocyanate. This polyurethane gel maintains a gelled state (soft gelled elastomer) regardless of the content of moisture, and has shape recoverability, recyclability, etc. As desired, one or more of lame (glitter), colorant, antioxidant and UV absorber may be added to the raw gel material.

The polyols used in the gel material G may include, for example, bi-functional polyol and/or tri-functional polyol or a mixture of two or more of these, and/or hydroxyl(—OH)-terminated polyurethane prepolymer. Other examples include polyether polyol, polyester polyol, polycarbonate polyol and polybutadiene polyol, and especially polyether-type polyol (polyalkylene polyol), for which the gel material shows good flexibility and resiliency, as is preferred. The isocyanate used may be, for example, polyisocyanate compound and the derivative and/or isocyanate (—NCO)-terminated prepolymer. Examples include, but are not limited to, MDI, TDI, IPDI, HDI, HMDI, PPDI and XDI. All of aliphatic, alicyclic and atomatic compounds are usable as an isocyanate, but it is preferred to choose an aliphatic isocyanate as non-yellowing type, especially if for long term use so there is no discoloration.

The covering 12 may also comprise polyurethane and, preferably, a 1-component polyurethane resin. This 1-component polyurethane resin is preferably a non-yellowing polyurethane resin, which does not yellow by light and heat. The non-yellowing polyurethane resin is made by preferably non-yellowing isocyanate compound and polyols. Examples of the non-yellowing isocyanate compound include aliphatic isocyanate as hexamethylene diisocyanate, isophorone diisocyanate, hydrogenated xylene di isocyanate(H6XDI), lysine triisocyanate, trimethyl hexamethylene diisocyanate, and in addition, non-yellowing xylenediisocyanate. As the above-mentioned polyols, a low molecule weight polyol and/or high molecule weight polyol can be used. Low molecule polyols are, for example, ethylene glycol, diethylene glycol, dipropylen glycol(DPG), 1,4-butanediol(1,4-BD), 1,6-hexanediol(1,6-HDO), neopentyl glycol, trimethylol propane. And polymer polyols are for examples, polyether polyol such as polytetramethylene ether glycol; poly-beta-ethyl-sigma-valerolactone, polycaprolactone; above-mentioned diols and polyester polyol consist of diprotic acid such as adipic acid, sebacic acid, suberic acid, isophthalic acid; in addition, polycarbonate polyol; epoxy polyol; polyether-ester polyol, acrylic polyol. Preferably, polyester polyol and polycarbonate polyol such as polyols which does not turn yellow easily are used. The softening temperature of this non-yellowing polyurethane resin is suitably 50 to 170° C., and more suitably 80 to 140° C. Such resin materials are available from NIPPON POLYURETHANE INDUSTRY CO., LTD. under the following trademarks: NIPPORAN 5120, NIPPORAN 5199, NIPPORAN 5196, and NIPPORAN 5230.

It is preferred for the hardness of a polyurethane gel raw material that hardness is within the limits of F50-C30, and it is more preferred for it that it is within the limits of F70-90. The F code is measured with the Aska F hardness scale, and the C code is the Aska C hardness scale. The “Aska C type” measuring instrument is based on the Society of Rubber Industry, Japan standards and SRIS 0101 is generally used. The Aska F type hardness scale (made by KOBUNSHI KEIKI CO., LTD) without a standard may be used for measurement of hardness lower than the Aska C type hardness scale.

As should be appreciated, the cross-sectional view in terms of height and width is provided for illustrative purposes only, and the overall dimensions may vary depending on the desired type of applicator. It should also be understood that the base layer B may form the top of the applicator 10, and the over layer O may form the bottom, in the usual orientation, but this is not required.

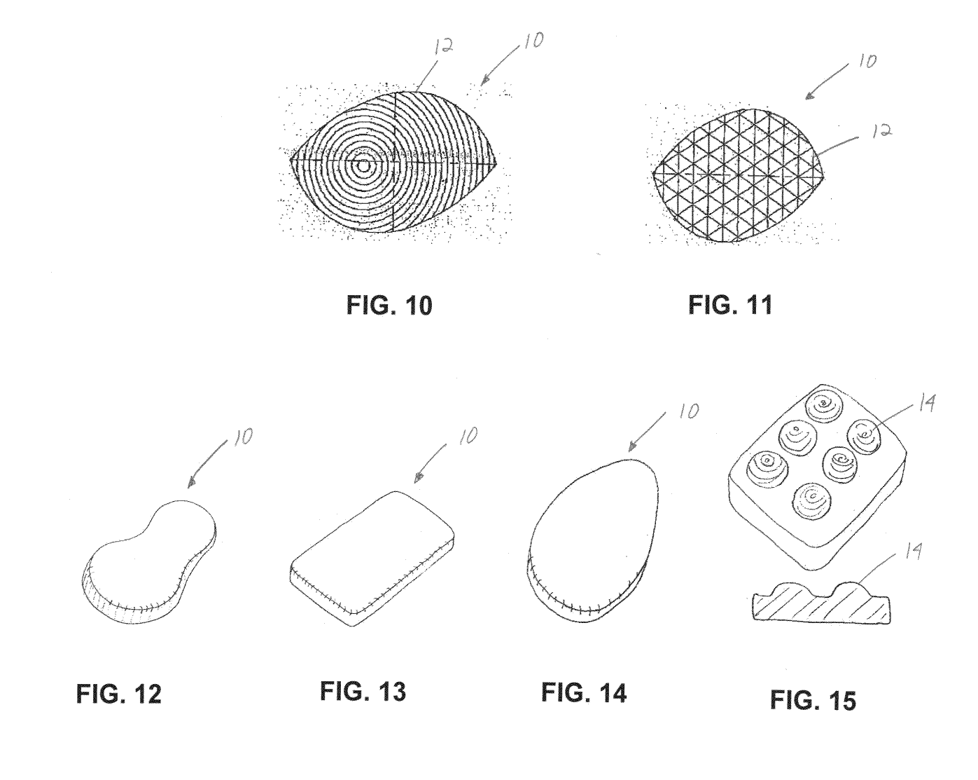

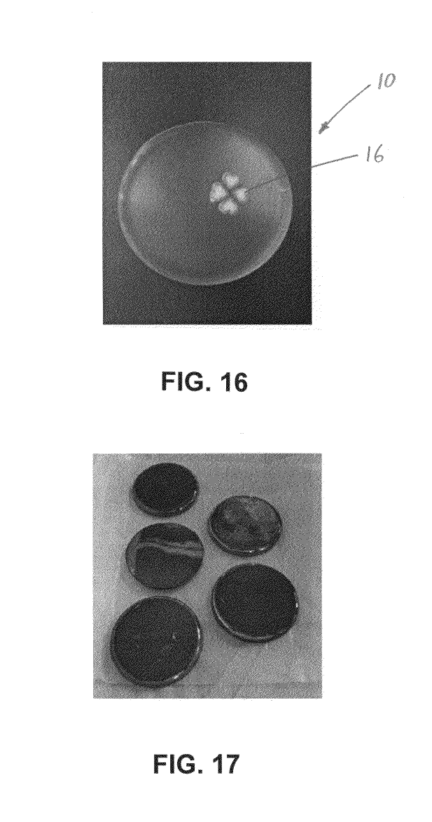

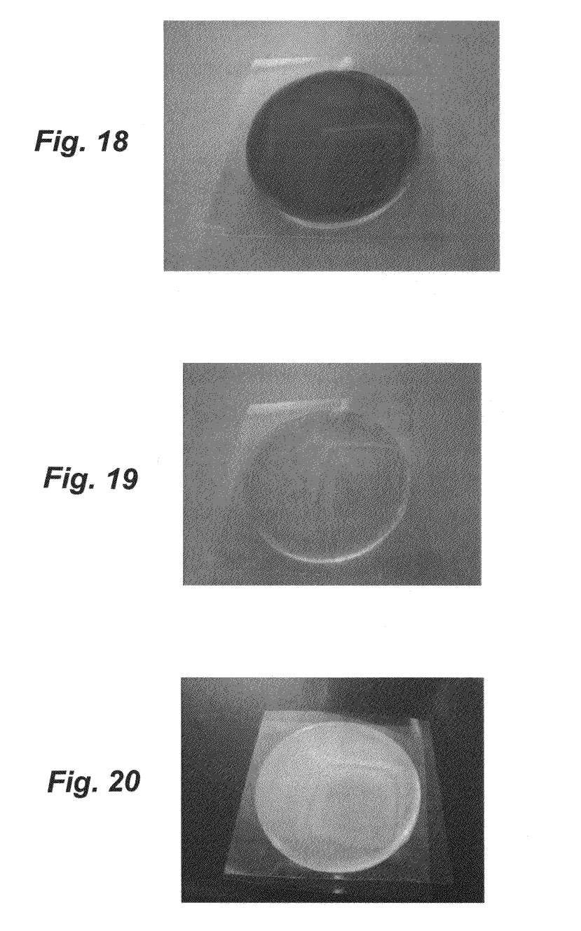

Referring to FIGS. 10-20, a variety of applicators 10 may be formed using the above-described techniques. For instance, as shown in FIGS. 10-11, it is possible to provide a particular surface texture, such as fingerprint (FIG. 10) or human skin (FIG. 11), by modifying the mold surface. Likewise, the mold shape may be adjusted to change the resulting shape of the applicator 10 (see FIGS. 12-14, which show oblong, rectangular, or ovoid shapes), or to provide it with surface projections 14 (FIG. 15). As shown in FIG. 16, an insert 16 may also be provided in the gel material G during the forming process, such as in the mold, to provide a decorative effect to the applicator 10. Material may also be deposited on the applicator 10 to provide it with a particular appearance (such as a mirror-like finish; FIG. 17). FIGS. 18, 19, and 20 illustrate specific examples of modifications, including color in the gel material (blue), glitter in the gel material (also in color (red/silver), and in the form of PET flakes), and mica in the covering 12, respectively.

The foregoing descriptions of various embodiments provide illustration of the inventive concepts. The descriptions are not intended to be exhaustive or to limit the disclosed invention to the precise form disclosed. Modifications or variations are also possible in light of the above teachings. The embodiments described above were chosen to provide the best application to thereby enable one of ordinary skill in the art to utilize the inventions in various embodiments and with various modifications as are suited to the particular use contemplated. All such modifications and variations are within the scope of the invention.

1. A cosmetic applicator, comprising:
a body including a covering fully enclosing a gel material, said covering including a molded portion and lacking any gate mark.

2. The applicator of claim 1, wherein the covering includes a non-molded portion.

3. The applicator of claim 2, wherein the non-molded portion comprises a spray coating applied to the gel material.

4. The applicator of claim 1, wherein the gel material comprises an elastomer.

5. The applicator of claim 1, wherein the gel material comprises polyurethane.

6. The applicator of claim 1, wherein the covering comprises polyurethane.

7. The applicator of claim 1, wherein the body has a hardness of about F50-C30.

8. A precursor for forming a cosmetic applicator using a mold having upper and lower portions forming a cavity, comprising:
a base layer positioned in the cavity;
a gel material at least partially covering the base layer; and
a cover for fully enclosing the gel material.

9. The apparatus of claim 8, wherein the cover comprises a sheet of material.

10. The apparatus of claim 8, wherein a surface of the sheet exposed to the gel material in the cavity includes a lubricious coating.

11. An apparatus for forming a cosmetic applicator including a gel material, comprising:
a mold portion including an open cavity;
a base layer for positioning in the open cavity; and
a dispenser for dispensing the gel material onto the base layer in the open cavity of the mold portion.

12. The apparatus of claim 11, further including a cover for covering the gel material.

13. The apparatus of claim 12, wherein the cover comprises a sheet having a lubricious coating for contacting the gel material.

14. The apparatus of claim 12, wherein the mold portion comprises a lower mold portion, and further including an upper mold portion for enclosing the cover, the gel material, and the base layer.

15. A method of forming a cosmetic applicator without a gate mark from a precursor having a cover over a surface of a gel material, comprising:
removing the cover from the precursor to expose the surface of the gel material; and
applying a layer to the surface.

16. The method of claim 15, wherein the applying step comprises applying the surface layer by spraying a material on the surface of the gel material not covered by the base layer.

17. The method of claim 15, further including the step of:
prior to the removing step, providing the gel material in a recess formed by the base layer.

18. The method of claim 15, further including the step of molding the gel material in the recess with the cover to form the precursor.

19. The method of claim 18, further including the step of rolling the cover onto the surface of the gel material.

20. The method of claim 18, further including the step of removing the cover before the applying step.

21. A method of forming a precursor for a cosmetic applicator, comprising:
providing a base layer having a recess including a gel material in a mold;
exposing a surface of the gel material in the recess; and
covering the exposed surface to fully enclose the gel material and form the precursor.

22. The method of claim 21, further including the step of molding the precursor.

23. A method for forming a cosmetic applicator including a gel material, comprising molding the precursor of claim 7.

24. The method of claim 23, further comprising the steps of:
removing the cover to expose a surface of the gel material; and
applying an over layer to the exposed surface to fully enclose the gel material, including by the base layer.

25. The method of claim 24, wherein the applying step comprises spraying a material on the exposed surface.
